(19) United States
(12) Patent Application Publication
(10) Pub. No.: US 2004/0249632 A1
(43) Pub. Date: Dec. 9, 2004

(54) Method and system for natural language recognition command interface and data management

(75) Inventor: Steven Chacon, Thornhill (CA)

Correspondence Address: CONLEY ROSE, P.C., P. O. BOX 3267, HOUSTON, TX, 77253-3267, US

(73) Assignee: ATC Dynamics, Inc., Thornhill (CA)

(21) Appl. No.: 10/861,986

(22) Filed: Jun. 4, 2004

(30) Foreign Application Priority Data
Jun. 5, 2003 (CA) 2,431,183

(51) Int. Cl. G06F 17/27

(52) U.S. Cl. 704/9

(57) ABSTRACT

A computer command panel and database system that is capable of receiving input in natural language either through commands or questions and returning the user's request. Input is separated into sequences of word groups to derive the data location, action and subjects where instruction sets are created and put through a command interpreter to deliver the user's request. Data is stored in a hierarchical data model that supports natural language querying. Network communication is possible to a remote server making extended data resources available via the Internet allowing a method to store as well as retrieve data. The invention supports a visual interface and keyboard, mouse, touch and microphone navigation to view data and to activate applications.

### FIELD OF THE INVENTION

The present invention relates to software for databases with a front-end command panel interface, more particularly, a system and method of retrieving data and activating applications through natural language. Software navigation is routed to the computer keyboard allowing users the opportunity to interchangeably use the keyboard, mouse, touch screen or microphone. The storage of data is accomplished by a data model that supports natural language querying through search methodologies with a command panel interface to view the data or to view the results of an application.

### BACKGROUND

In recent years, much progress has been made to computer processor speeds, voice recognition technology and database engine query retrieval rates. The mass traffic of the Internet and enormous data content results in information overload and disorganization for the user. Internet search engine keyword strategies have the disadvantage that users must be familiar with the appropriate key word terms to retrieve desired data records. Mixing data from incompatible data sources are difficult for search engines and often irrelevant information is aggregated with relevant information. User interfaces that are simple to operate should have the capability to handle almost any type of input and the user should have the ability to accurately retrieve and store diverse and accurate information upon request.

Graphical User Interfaces (GUI) are at a disadvantage since the user must switch between using the mouse and keyboard if the keyboard is used for input. This action slows down the information retrieval process for the following reasons: data objects must be visible to the user in order to be activated; data objects are saved in various formats (text, Word documents, Adobe Acrobat, etc.) requiring special applications for viewing the data; and data display interfaces and navigation for scrolling data objects are non standardized.

Building databases with search engines and front-end user friendly interfaces to allow easy retrieval and storage of data can be time consuming and costly to build and deploy since, with present technologies, custom data modeling is required for data that is categorically divided.

The Internet offers the advantage that a client computer system can make a connection to a remote server or, more particularly, communication with a central computer's data resources with the proper security clearance. The limitations of present security protections or firewalls are that Internet Browsers support open source and macro scripting which allow hackers to control application and operating system behavior.

Communicating with a computer through a user interface is more effective using natural language when the user can use a language as ordinarily spoken or written by humans such as English. Natural language is governed by rules and conventions sufficiently complex and subtle allowing frequent ambiguity in syntax and meaning. Once the computer understands the language being inputted, tasks and meanings can be distinguished by the ordering of word groups.

What is needed then is a software system that has an interface with a combined operation of a Graphical User Interface (GUI) and a command prompt. Behind this interface is a method to retrieve data from the server side to the client system through natural language and to store diverse data in an organized format. Security must identify the system accessing the remote server as well as the user's id and password.

### SUMMARY

The present invention provides a simple interface that acts as a command panel divided into three sectors supporting the 1) output screen, 2) menus or coordinates for the output screen and 3) keyboard functions.

Data and electronic activation are provided through command system where command input is analyzed and parsed to determine sentence structure and to derive the appropriate action.

Data is stored within a hierarchical database model where the command line search is based on category location. Categories are divided into Titles, which are further divided by Pages.

In accordance with one embodiment of the invention, a client computer system and file server provides the environment and the operating system to retrieve, view and display data within a secured and encrypted closed architectural system.

### BRIEF DESCRIPTION OF THE DRAWINGS

FIG. 1A is high-level illustration of a networked computer system maintaining a client/server operating environment.

FIG. 1B is high-level illustration of a networked computer system maintaining the operating environment for the claimed embodiments of the invention.

FIG. 1C illustrates the communication on the server side with the invention file server.

FIG. 2A illustrates the computer user interface.

FIG. 2B illustrates the computer user interface's keyboard and menu navigation.

FIG. 2C illustrates the title formatted data body displayed in the output screen.

FIG. 2D illustrates the editable raw data body displayed in the output screen.

FIG. 3A illustrates the user request path to deriving meaning from user input.

FIG. 3B illustrates the user request delivered to the user from input.

FIG. 4A illustrates the data object of the natural language recognition data model.

FIG. 4B illustrates the hierarchy of the natural language recognition data model.

FIG. 4C illustrates the logical navigation of data objects within the natural language recognition data model.

### DETAILED DESCRIPTION

The following discussions are intended to provide a brief, general description of a suitable computer environment in which the invention may be implemented. The invention may be described by reference to different high-level program modules and data objects and/or low-level hardware contexts. Those skilled- in the art of programming will realize that the program module references can be interchanged with low-level instructions.

Program modules include procedures, functions and data structures, and the like, that perform particular tasks or implement data objects. The modules can be incorporated into single or multi-processor systems on the client and server side.

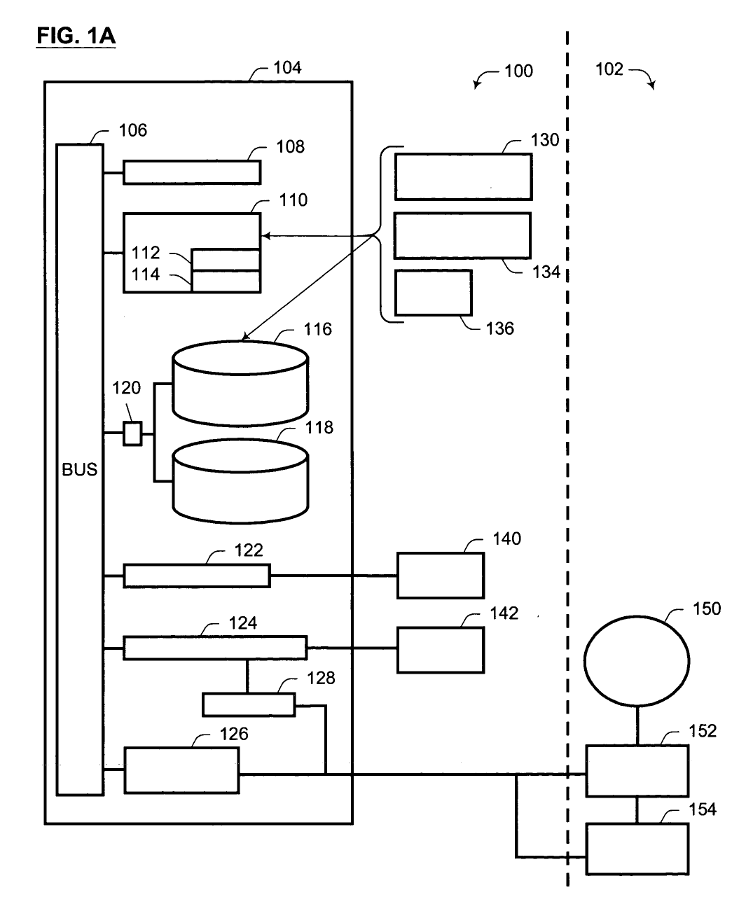

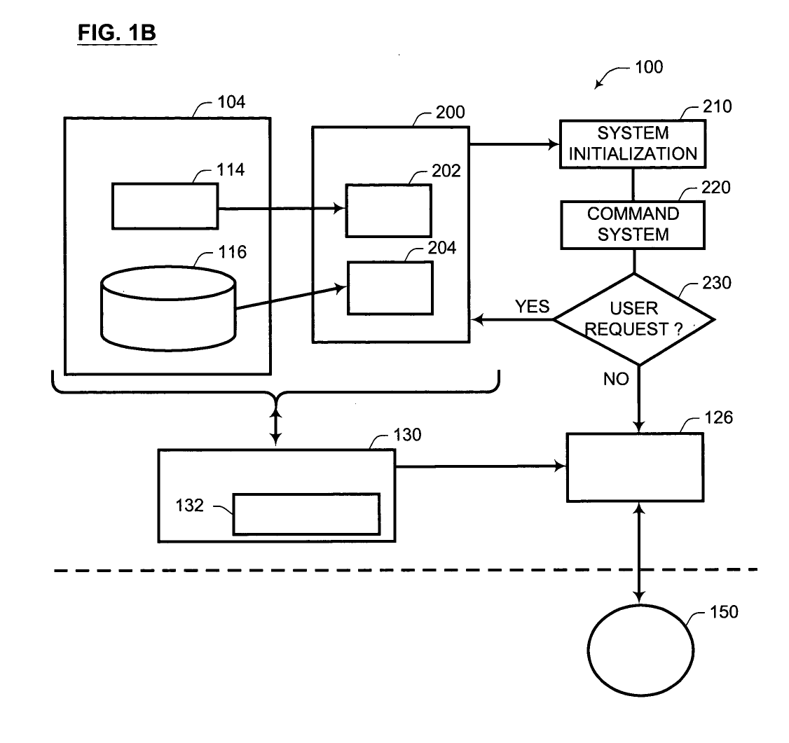

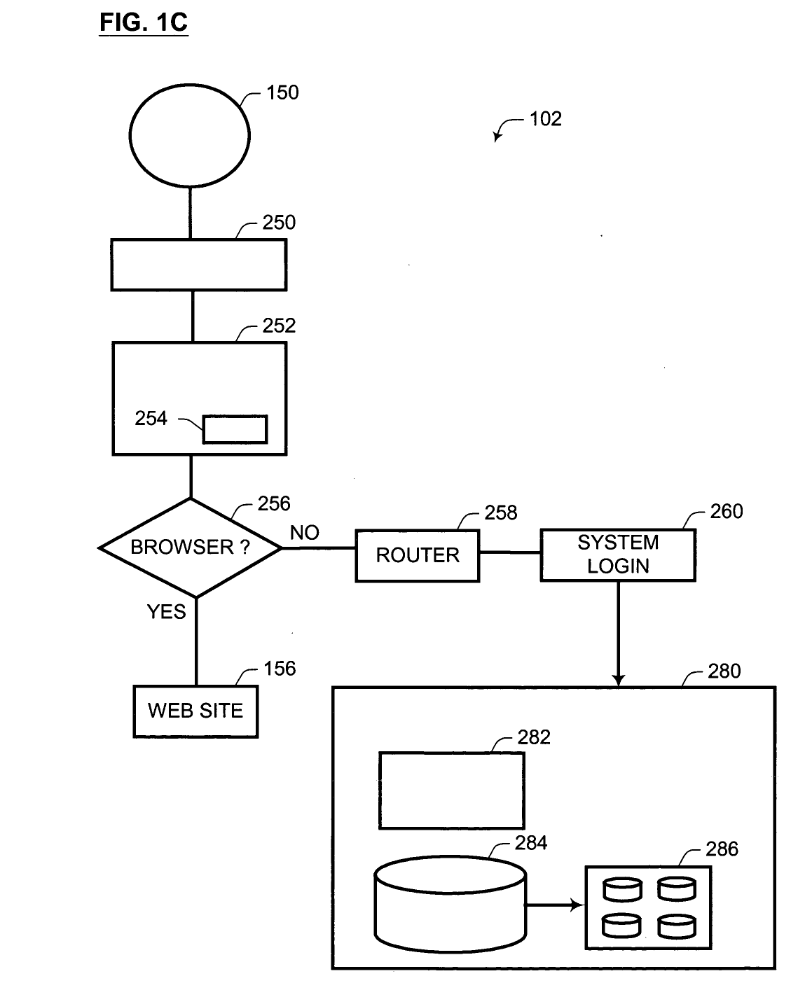

FIG. 1A illustrates a typical configuration of a client 100 server 102 computer environment. A system for implementing the invention includes a computing device 104 having a system bus 106 for linking various components of the computing device. The system bus 106 can include various bus architectures such as ISA, EISA, VESA, PCI, etc. Typically, attached to the system bus 106 are the processor 108, memory 110, fixed storage device 116, removable storage device 118, video card 122 interface, interface (input/output) ports 124, and the network interface 126.

The processor 108 may be any variety that supports IBM personal computer compatibility such as Intel, AMD, PowerPC, etc. The system memory includes read-only memory (ROM) 112 and random access memory (RAM) 114. ROM 112 contain basic input/output system (BIOS) which are routines for information transfer between the computing device 104 and system initialization.

The fixed storage 116 generally refers to a hard drive medium or a series of hard drives accessible by the computing device 104. The removable storage 118 generally refers to a device bay into which removable mediums such as floppy disks, CD-ROM, DVD or CD-RW are used. Both the fixed storage 116 and removable storage 118 are coupled to the system bus 106 by a disk controller or device interface 120.

The computing device 104 can store and execute program modules within RAM 114 and the storage devices 116 and 118. Typical program modules include the operating system 130 (e.g. DOS, Windows, UNIX), application software 134 and application data 136 such as configuration files and registries. Program module or system output can be processed by the video card 122 that is coupled to the system bus 106 and an output device 140. Typical output devices include monitors and liquid-crystal displays (LCD).

A user of the computing device 104 is typically a person interacting with the computing device through the manipulation of an input device 142 such as a keyboard, touch sensitive screen, mouse, microphone, digital pen, etc.

The computing device 104 is expected to operate in a network environment using network application protocols to an Internet service provider (ISP) 152, a local area network (LAN) or a wide area network (WAN) with Internet 150 connections. The computing device 104 has a network interface 126 (e.g. Ethernet Card, D-Link) coupled to the system bus 106 to allow communication with the server side 102 which includes an Internet Service Provider (ISP) 152 or a network server 154 with a connection to the Internet. Communication can also be established through a modem 128 which is coupled with the interface ports 124.

The present invention is described with reference to acts and symbolic representations of operations that are referred to as being computer executed. It will be appreciated that the acts symbolically represent operations performed by the processor 108 where electrical signals and data bits are transmitted between memory 110 and storage devices 116,118.

When in use, the invention is expected to reside on a fixed storage device 116 in the form of binary files that is supported by the operating system 130 and the File Access Table (FAT). The invention is expected to require a network interface 124 supported by application software 134 provided by the Internet Service Provider (ISP).

FIG. 1B illustrates the invention in relation to the computing device's 104 storage mediums. Through the operating system 130 initialization, a drive letter is assigned to space in the random access memory (RAM) and data drive 204 make up the storage mediums for the client system 200. In cases where a RAM drive 202 is not possible to configure on the client-computing device 104, a drive letter different from the data drive 204 is used. In cases where the client computer has only one drive letter, a logical RAM drive 202 is created on the data drive 204.

Once the client system 200 goes through system initialization 210 and the command system 220 is activated, user requests 230, 400 can be fulfilled by the client side 100 initially, then routed up to the server side 102 if the user request is unsatisfied by the client computing device 104. Data is routed downwards to the client side 100 from the server side 102 to the client computing device 104 and is displayed by the client system's 200 interface. On the client side 100, a connection is made to the network interface 126 either through network communication applications, which reside in the operating system 130, or through an X windows session 132 where communication with a remote server is established. Communication to the Internet 150 is established through the command system's 220 data instruction transfer and through the data transfer of proxy settings.

When in use, the invention is expected to reside in an idle state on the fixed storage device 116. When the system is activated, program files and databases are copied onto the RAM drive 202, then the system is activated. The system continues to reside on the RAM drive 202 until the system is exited after which the RAM drive 202 is cleared.

When operating the invention the user begins system initialization 210 by supplying a user id and password. Through the command system 220, user requests 230 are satisfied either by the client or server system's database resources. For example, if a user asks the system “Who is Thomas Edison?” and if the client system 200 does not know the answer then the server system 280 will either produce an answer or return a command failure message.

FIG. 1C illustrates the server side 102 communication with the server system 280. Through proxy settings, communication is established from the Internet 150 to the web server 250. The uniform resource locator (URL) 254 activates the proxy detection 252. The next step is to determine if an Internet browser (Microsoft Internet Explorer, Netscape Navigator, AOL, etc.) 256, or more particularly, HTML scripting is being used. If an Internet browser is being used then the web site 156 will be displayed in the Internet browser. If an Internet browser is not being used then the proxy settings go through a network router 258 to reach a system login 260 which verifies the invention's encryption code, user id and password. The interface and processing occurs at the client side 100 while communication with the server system 280 provides extended data resources. The server system 280 contains a communication buffer which is provided by the network RAM drive 282 and data resources which are provided by the network data drives 284. Network data drives 284 can be routed to remote file servers with access to storage mediums 286 such as hard drives, drive racks, optical drives, etc.

On the server side 102, when in use, user requests 230 are routed through the Internet 150 where the Web server 250 detects the client system 200. The connection is then routed from the Web server 250 to the server system 280. The client system 200 supplies an encrypted code and the user id and password from system initialization 210 to gain access to the server system 280.

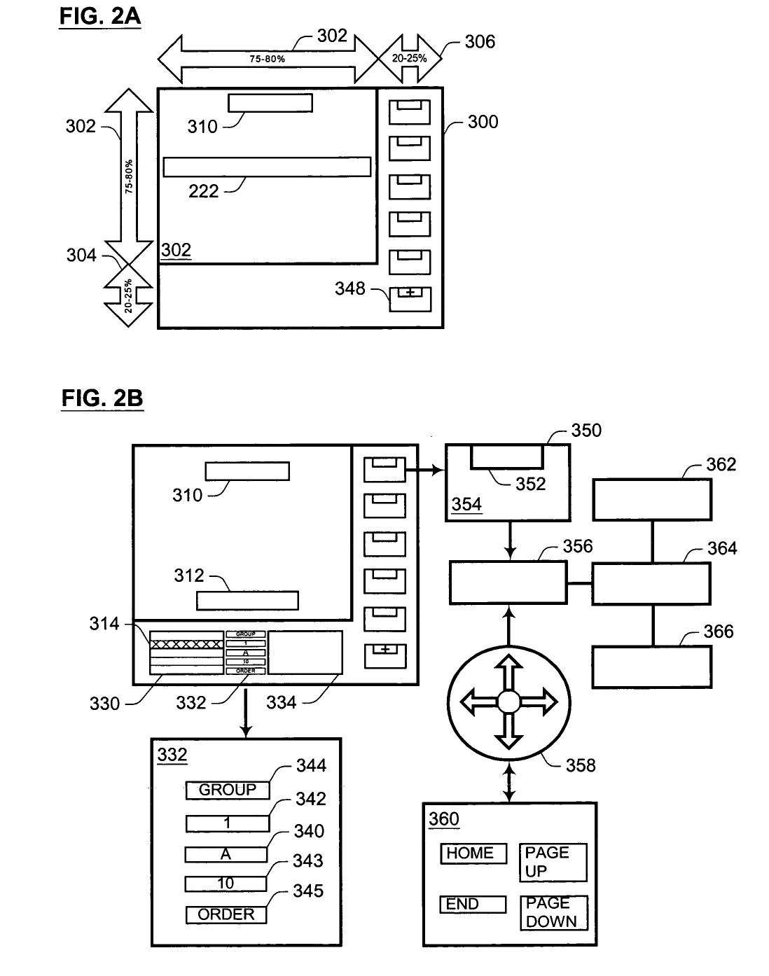

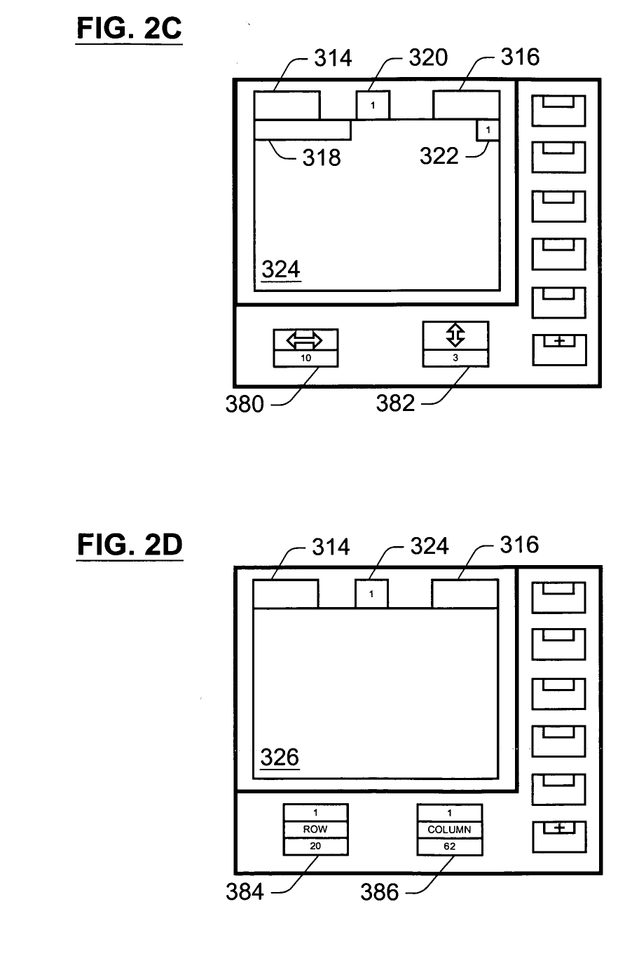

FIG. 2A illustrates the computer user interface 300 commonly displayed by the video card 122 through an output device 140 such as a monitor or liquid-crystal displays (LCD). The interface is divided into three sectors 302, 304, and 306.

Sector one 302, described as the main viewing area, is located at the top 75-80% of the full horizontal and vertical screen. Sector one 302 displays raw data and/or application titles 310 and control functions such as the command system input prompt 222 where commands and questions are inputted.

When the command system input prompt 222 is in use, the user's input would be displayed within the rectangle starting from the left.

Sector two 304 is described as an area where additional information is available for sector one 302. Sector two 304 is the bottom 20-25% of the full vertical screen.

Sector three 306 is described as the area where the keyboard or key functions are displayed. Sector three 306 is the right 20-25% of the right horizontal screen. Sector three 306 can display five sets of key functions at a time where each set is displayed in order through the “more” key function 348.

For example, if an application requires twelve key functions to operate, the first five key functions are displayed when the application is first activated. When the “more” key function 348 is activated the following sequence of five key functions or less are displayed. At the end of sequence the first five key functions are displayed.

FIG. 2B illustrates the computer user interface's keyboard and menu navigation. The sets of functions activated in sector three 306 are each linked to a unique key or ISO key code on the input device 142 keyboard. Keyboard navigation is accomplished by the key function 350, which identifies the key to press 352 and name of the function 354 to activate. The key identification 352 remains red in an idle state and green if the key function 350 is activated. If the key function 350 is activated and the key identification 352 is blinking then key function 350 must be activated a second time to confirm the activation otherwise, any other key function cancels the confirmation. Keyboard navigation 356 is also achieved through mouse navigation 362 by placing the mouse cursor over the key function 350 and clicking once to activate the application. Touch navigation 364 is achieved by physically touching the key function 350 on a display panel and microphone navigation 366 is achieved by naming the key identification 352 or the key function 354 through a microphone.

Sector one 302 displays the application title 310 with the highlighted menu item category's full title 312 and the full or partial category title displayed in the bounce bar 314 and the menu boxes 330, 334.

The menu selector 330 and 334 displays five menu items on each side of the menu index 332. The maximum number of menu items that is displayed at one time is five or ten. To position the bounce bar 314, keyboard navigation pertaining to positioning keys 358, 360 consisting of the up, down, left and right arrows moving one position up or down, to the left box 330 and to the right box 334. The home and end key positions the bounce bar at the first and last menu position. Page up and page down scrolls up and down five or ten positions.

The center of the menu selector 332 displays to the user the first character reference 340 of the bounce bar 314 position. All positions above and below the first character reference 340 are toggled; if displayed, then assume on, if not displayed then, assume off.

The first character reference 340 ignores leading spaces and zeros and always displays the first character of the bounce bar 314. The first character reference 340 is displayed in green as the bounce bar 314 is positioned to signify an idle state. Word patterns can be spelled out where the first character reference 340 is displayed in cyan as each subsequent letter is inputted which positions the bounce bar 314 to support word pattern searches through the menu items. To successfully input a spelled out word pattern, the input process is delayed 0.3 seconds after the first letter is inputted and 0.7 seconds for each subsequent letter inputted. The most commonly used method of inputting a word patterns is through an input device 142 such as a keyboard or microphone.

For example, if the user's request is “List Inventors”, a list of menu items appears in the menu selector 330, 334. If “Edison, Thomas” is highlighted in the bounce bar 314, then the letter “E” will appear in the first character reference 340. If the user types each subsequent letter of the menu item, such as “(E)DISON . . . ” the bounce bar 314 will remain at its current position until the letter entered does not match the menu item pattern at the current bounce bar 314 position. The bounce bar 314 will then continue to find a menu item that matches the new set of characters entered amongst the list of menu items.

The menu record position 342 and 343 refers to the position of the bounce bar 314. The current record position 342 and the total number of menu records 343 are displayed.

For example, if fifteen inventors are listed in the menu selector 330, 334, the user can press the page down key three times to view the complete list. Below the first character reference 340 the number “15” is displayed and the current record position “1 . . . 15” of the bounce bar 314 is displayed above the first character reference 340.

If Group 344 and Order 345 are not displayed then the menu selector is displayed in singular mode. If Group 344 is displayed then the menu selector is displayed in group mode where the category is displayed in the left menu box 330 and the group that the category is part of is displayed in right menu box 334. Two bounce bars are displayed at the same position on either side of the left menu box 330 and the right menu box 334. If Order 345 is displayed then the first character reference 340 of the right menu box 334 bounce bar 314 position is displayed otherwise if only Group 344 is displayed then the first character reference 340 of the left menu box 330 bounce bar 314 position is displayed.

For example, if the user's request is “List Inventors” and the Group 344 toggle is on, a list of inventors, or more particularly, a list of categories appears in the left menu selector 330 and the category's associated group name “Inventors” appears in the right menu selector 334. The user can input characters through the first character reference 340 to search amongst the category menu items. If the Order 345 toggle is on, then the user inputs characters to search amongst the group menu items.

FIG. 2C illustrates the title formatted data body 324 displayed in sector one 302. The main body of data 324 is displayed with its category title 314, group title 316, data title 318, data title position 320 and data body page number 322. To accompany sector one 302, displayed in sector two 304, is the maximum number of title positions 380 and maximum number of pages 382.

For example, if the user selects “Edison, Thomas” from a list of inventors, “Edison, Thomas” is displayed as the category title 314, “Inventors” is displayed as the group title 316 and “Introduction” is displayed as the first data title 318. The user navigates between the data titles 318 associated with the category titles: “Introduction”, “Childhood”, “Early Inventions”, etc. Using the left and right directional key functions 358, the user navigates between the data titles 318 and using up and down directional key functions 358 navigates between the pages of the data title 318.

If the record “Edison, Thomas” contains nine titles and currently displayed is the third title position 320 on the fifth of twelve pages. Then, the number “3” is displayed as the title position 320, the number “5” is displayed as the data body page number 322, the number “9” is displayed as the maximum number of title positions 380 and the number “12” is displayed as the maximum number of pages 382.

FIG. 2D illustrates the editable raw data body displayed in sector one 302. The raw data body 326 is displayed with its category title 314, group title 316 and page number 324. To accompany sector one 302 the position coordinates 384, 386 of the cursor are displayed. The row position 384 displays the two row positions, the position from the top and the position from the bottom. The column position 386 displays the two column positions, the column position from the left and the column position from the right.

For example, if the user is editing the record “Edison, Thomas” and the record contains two hundred and thirty lines of data, “Thomas, Edison” is displayed as the category title 314, “Inventors” is displayed as the group title 316 and the data is displayed in the raw data body 326. If the forth page of two hundred and thirty lines of data is divided by the maximum row length, then the number “4” is displayed as the page number 324.

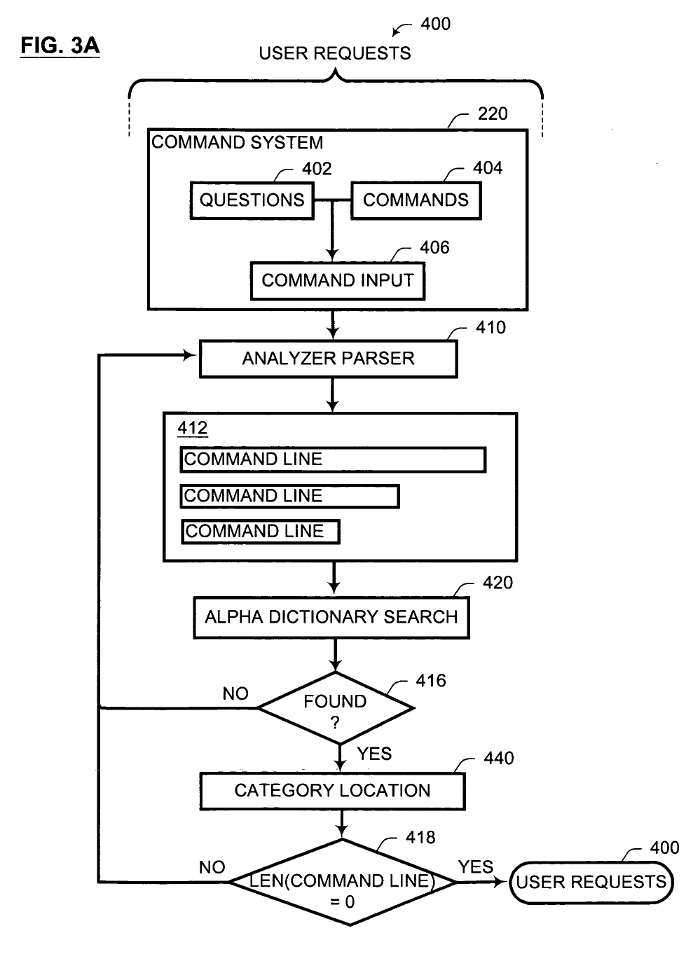

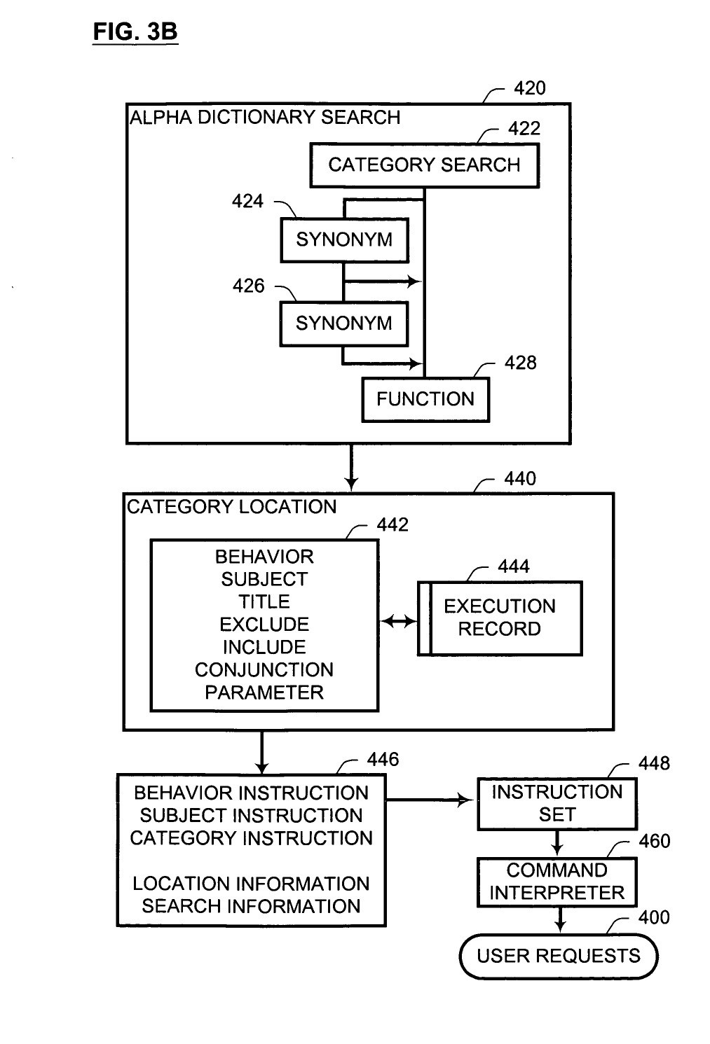

FIG. 3A illustrates the user request path to deriving meaning from user input. User requests 400 or, more particularly, questions 402 or commands 404 are inputted through the command system 220, 222 where command input 406 is entered through an input device 142, such as a keyboard or microphone. An analyzer parser 410 then divides the command input 406 into command line sequences 412 starting with the end of the line to the beginning. Each command line 412 goes through an alpha dictionary search 420. If the command line 412 is found in the alpha dictionary 416 then the category location 440 of the command line is established. If the command line is not found in the alpha dictionary 416 then the command input 406 is further parsed 410 by systematically deleting each word from the end until a category location 440 is found.

Once the category location 440 is established for a command line 412, the command input 406 is further parsed 410 by deleting the command line 412 from the command input 406. If the command input 406 length equals zero 418 then either all-possible category locations 440 are established or no meaning was derived from the command input 406. If no meaning was derived from the command input 406 then the command input is routed to the server side 102 or, more particularly, to the server system 280 where extended data resources 284, 286 are used to fulfill the user requests 400.

For example, if the user inputs the question “Who is Thomas Edison?” or the command “List Inventors”, the command line 412 is parsed 410 and searched through the alpha dictionary 420 until the words “Who is” or “List” is found. The command line 412 is further parsed and searched until the words “Thomas Edison” or “Inventors” are found. The command line 412 is further parsed until its length equals zero 418 at which time the user request's instruction set is processed resulting in success or failure.

FIG. 3B illustrates the user request 400 delivered to the user from input. The alpha dictionary search 420 or, more particularly, the category search 422 tries to locate the category function 428. This is accomplished either directly, if the command line 412 is the same line as.the category function 428 or indirectly by searching through a series category synonyms 424, 426 of the category function 428.

For example, if the user inputs the question “Who is Thomas Edison?”, the word group “Who is” is a synonym 424 of the function 428 behavior “Retrieval” and “Thomas Edison” is a synonym 424 of the function 428 subject “Edison, Thomas”. Another example is where “Tom Edison” is a synonym 424 of “Thomas Edison” which is also the synonym 426 of the function 428 subject “Edison, Thomas”.

Once the category function 428 is established then the category location 440 can provide the necessary information to build the instruction set 448. The category location 440 or, more particularly, the execution record 444 provides meaning of the category 442 by determining behavior, subject, title, exclusion statement (e.g. except, not including, etc.), inclusion statement (e.g. only, including, etc.), conjunction (and, but, or) and parameter (e.g. number, keyword, level setting, etc.).

For example, if the user inputs the command “List Thomas Edison's early inventions”, the word “List” is the behavior, the word group “Thomas Edison” is the subject and “early inventions” is the title. If the user inputs the command “Who is Thomas Edison and Benjamin Franklin?” the word “and” is the conjunction resulting in two questions being answered. If the user inputs the command “Who is Thomas Edison and Benjamin Franklin include only early inventions?” or “Who is Thomas Edison and Benjamin Franklin excluding childhood?”, the search is narrowed to include or exclude the titles “early inventions” or “childhood”.

The meaning of a category location is translated into instructions combined with location and search information 446. Behavior instruction determines the action to be committed and the subject and/or category instruction determines the outcome of the action. Together with the location and search information the instruction set 448 is constructed and the command interpreter 460 provides the user requests 400.

For example, to retrieve information on “Thomas Edison”, the system first determines the action is “Retrieval” and the location of the subject. Establishing the location of a search category 440 allows rules to be applied to the action received from the user. The action of retrieving a subject combined with the location of the category 440, an instruction set 428 outlining the retrieval steps is executed through the command interpreter 460.

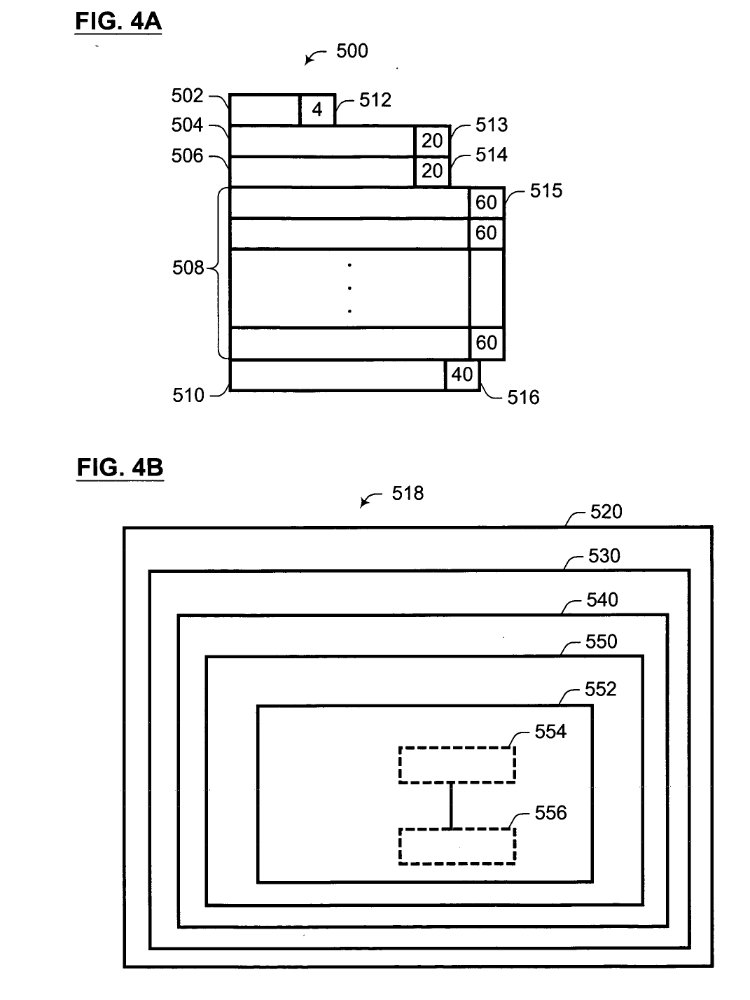

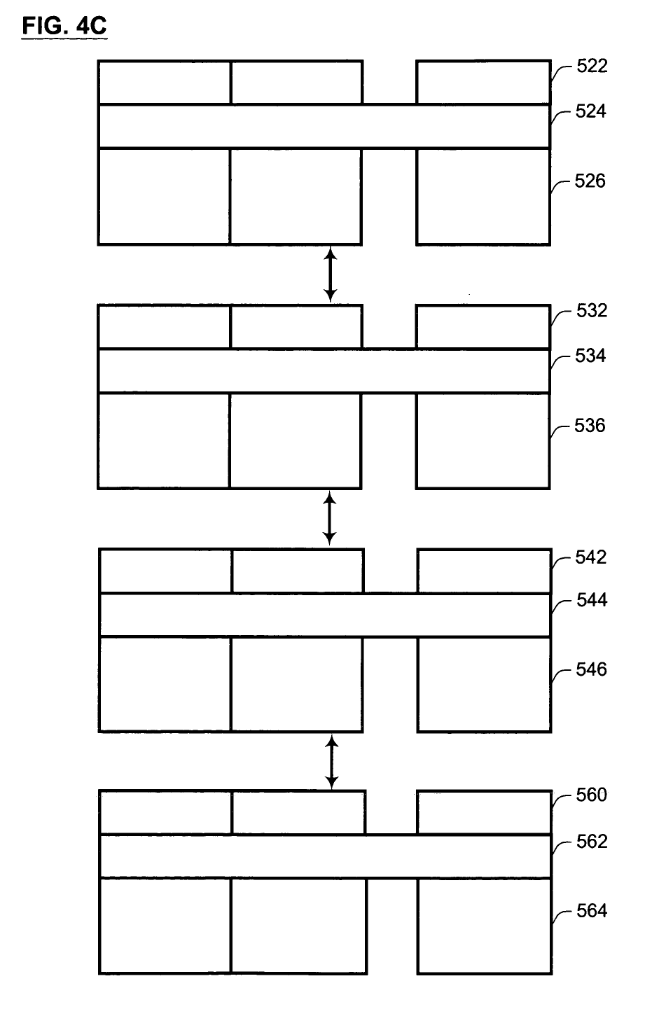

FIG. 4A illustrates the data object 500 of the natural language recognition data model 518. The data object 500 or, more particularly, the data record generally consists of fields created and defined by a database engine (e.g. Oracle, DB2, Sybase, Dbase, etc.). Fields contain data characterized by data types (e.g. character, number, Boolean logic, date/time, etc.). Fields are stored within databases or tables within a database and are retrieved through querying methods such as SQL (Structured Query Language) and eventually displayed.

The purpose of a data object 500 is to store raw data randomly in a database that is retrievable through its reference information. The data object 500 fields are all character or alphanumeric data types consisting of the page number 502, category title 504, group title 506, line body 508 and encryption code 510. Each field of the data object 500 contains a fixed width character length. Illustrated in FIG. 4A are the data object's 500 minimum character lengths 512, 513, 514, 515 and 516 which are defined through a database engine's database creation process.

The category title 504 and group title 506 represent the unique identifier of the data object 500 and the page number 502 links data objects to the category title 504 and group title 506. If the page number 502 equals zero then only one data object exists for the category title 504 and group title 506. If the page number 502 is equal to one then there are at least two data objects linked to the category title 504 and group title 506. Search algorithms use the category title 504 combined the group title 506 and the page number 502, equal to zero or one, to locate the first data object of a specific category title 504 and group title 506.

The line body 508 contains the data associated with the category title 504 and group title 506. The number of lines of the line body 508 is predetermined when a database is created for a data object 500 and is used to effectively manage disk space. If the data size exceeds the number of lines in the line body 508 then a new page number 502, or more particularly, a new data object 500 is created and the data is stored into subsequent line body 508. If the database created is to contain referential data or only a few lines of data then a minimum of two lines are created for the line body 508. If the database created is to contain a large mass of information then the more lines that are created, the fewer number pages 502 are required. The maximum number of lines a line body 508 can contain depends on a variety of storage strategies. For example, the more lines in the line body 508 and the more pages 502 being used, the larger the database will be in bytes.

Each data object 500 contains a field for the encryption code 510. The encryption code 510 is related to the sign-on security and system serial number. Each data object that is transferable is also traceable to a specific system 200, 280. This allows the retrieving and displaying of data to be secure down to the data object 500.

FIG. 4B illustrates the natural language recognition data model 518. The data model 518 is a top down hierarchy consisting of databanks 520, databases 530, groups 540, categories 550 and data pages 552.

Databanks 520 are related to directories or folders that reside on disk drives which are created and supported by the operating system 130. Each databank 520 contains a set of databases 530, which are related to the databank 520 name. For example, a healthcare databank would contain databases relating to healthcare data. A database 530 is a file created by a database engine, which contain the attributes of the data object 500. Supported by the data object's 500 field structure, the database 530 is logically divided into groups 540. Each group 540 contains a set of categories 550. Each category 550 contains a single data page or a set of data pages.

A data page 552, or more particularly, a data object 500 can store raw data in the line body 508 or it can be logically divided into titles 554 by referencing the title 554 within the line body 508. A title 554 subdivides a category 550 into data blocks that relate to the category's 550 content. Each data title 554 is logically divided into title pages 556. The number of lines each title page 556 contains equals the height of the display of the main body of data 326.

For example, the “Thomas Edison” category or data object 500 would be located in data model 518 through the hierarchy: “Data” databank 520, “Encyclopedia” database 530, “Inventors” group 540 and “Edison, Thomas” category 550. The category 550 is divided into titles 554: “Introduction”, “Childhood”, “Early Inventions”, etc. Each title 554 is further divided into pages 556.

FIG. 4C illustrates the logical navigation of data objects within the natural language recognition data model 518. By dividing a database 530 into logical groups 506, 540, lists consisting of only category titles 504 or category titles 504 with group titles 506, are displayed in the menu selector 330, 334. Through user selection, navigation within the data model 518. This is possible through the selection of category titles 504, 550, 522, 532, 542, 560 and filtering information and parameters contained within the data object's 500 data pages 552, 526, 536, 546.

In order to reach, a data page 552, 564, through the data model 518, a four step selection process is required: starting with the databank 520 selection; then the database 530 selection; then the group 540 selection; and finally the category 550 selection where the data page 552, 564 is retrieved and displayed. As illustrated in FIG. 4C, by listing a set of databanks 522 from a default system group 524 and selecting a specific databank 522, 534, a set of database names 532 are displayed in the menu selector 330, 334. By selecting a database name 522, a set of group names 532, associated with the selected database name 534, are displayed. By selecting a group name 532, a set of category names 542, associated with the group name 532, are displayed with its associated data pages 546.

For example, if the user is to locate the category “Edison, Thomas” through the data model's 518 logical navigation, a list of databanks 522 is listed in the menu selector 330,334 where the user selects “Data”. A list of databases 532 contained within the databank 534 is then displayed in the menu selector 330,334 where the user selects “Encyclopedia”. A list of groups 542 contained by the database “Encyclopedia” 544 are then displayed in the menu selector 330,334 where the user selects “Inventors”. A list of categories 560, or more particularly, a list of inventors are then displayed in the menu selector 330,334 where the user selects the category “Edison, Thomas”.

1. A method for selecting and retrieving data from a database comprising the steps of:
inputting a question or command to said database by means of natural language;
processing said natural language question or command in a command interpreter; and
retrieving and displaying said data through a user interface.

2. The method of claim 1 wherein natural language comprises any spoken language.

3. The method of claim 2 wherein the inputting can occur through commands, keyboard, mouse, touch or microphone navigation.

4. A method according to claim 1, wherein said data is retrieved and displayed through said user interface where the category, group, title, page, title number and page number is displayed in the body of the retrieved data.

5. A method for activating applications within a computer, network or server, comprising the steps of:
inputting a request for an application to said computer, network or server by means of natural language;
delivering said natural language request to a command interpreter; and
returning said application to a user interface.

6. The method of claim 5 wherein natural language comprises any spoken language.

7. The method of claim 5 wherein the inputting can occur through commands, keyboard, mouse, touch or microphone navigation.

8. A system that supports keyboard navigation as a first method of controlling a computer system, said system comprising:
a means of identifying a keyboard key identifier displayed by a user interface;
a means of identifying a keyboard key function displayed by the user interface;
a means of activating a function through said displayed keyboard function.

9. The system of claim 8 further comprising a second method of controlling the computer system comprising the use of a mouse, touch screen or a microphone.

10. A method according to claim 9, wherein the keyboard key identifier and the keyboard key function are identified to a user by the user interface at all times.

11. A method according to claim 10, wherein mouse navigation is possible by clicking on the displayed keyboard function.

12. A method according to claim 10, wherein touch navigation is possible by touching the displayed keyboard function.

13. A system according to claim 10, wherein microphone navigation is possible by naming the keyboard key identifier or the keyboard key function displayed.
